(19) United States
(12) Patent Application Publication
(10) Pub. No.: US 2025/0074073 A1
(43) Pub. Date: Mar. 6, 2025

(54) METHOD AND DEVICE FOR APPLYING PATTERNS TO A WORKPIECE, AND COMPUTER PROGRAM

(71) Applicant: HOMAG GmbH, Schopfloch (DE)

(72) Inventors: Felix KRESPACH, Vöhringen (DE); Boris THIESSEN, Rheda-Wiedenbrück (DE); Jana BETHKE-JEHNERT, Freudenstadt (DE); Patrick MÜLLER, Glatten (DE)

(21) Appl. No.: 18/719,217

(22) PCT Filed: Dec. 13, 2022
(86) PCT No.: PCT/EP2022/085542

§ 371 Date: Jun. 12, 2024

(30) Foreign Application Priority Data
Dec. 14, 2021 (DE) 10 2021 133 046.7

(51) Int. Cl. B41J 3/407; G06F 3/12

(52) U.S. Cl. CPC B41J 3/407; G06F 3/1208; G06F 3/1257

(57) ABSTRACT

Method for applying patterns to a workpiece which is preferably composed at least in portions of wood, wood material or plastic, having the steps: performing at least one selection in terms of a decor for the application of patterns to the surface of the workpiece, computer-assisted generation and/or adapting of at least one image file taking into account the at least one selection, and at least partial application of patterns to the workpiece by means of a printing device.

### TECHNICAL FIELD

The invention relates to a method and a device for applying patterns to a workpiece which is preferably composed at least in portions of wood, wood material or plastic, wherein patterns are applied to the workpiece at least partially by means of a printing device.

### PRIOR ART

In the field of the furniture and component industry, patterns are often applied to the surface of workpieces, for example by applying coatings to which patterns are applied. Alternatively, it is also possible to provide the surface of workpieces with a desired pattern by means of a printing device. A corresponding device is disclosed, for example, in EP 1 726 433 A1.

Print templates and/or image files which can represent, for example, specific wood grains or any other desired pattern can be used as a basis for printing workpiece surfaces. These print templates and/or image files can also be obtained by scanning in a surface of the workpiece to which patterns have already been applied, such as, for example, in EP 3 415 329 B1.

The printing of workpieces has the advantage that the specification of the decor can be performed at a late point in time and that the warehousing can be reduced and the variety of variants can be increased. It has nevertheless been shown that, even in the case of printing workpieces, there is a demand for increased variety of variants and/or individualization, and that ever higher demands are being placed on the quality of printed workpiece surfaces.

### DESCRIPTION OF THE INVENTION

The object of the invention is therefore to provide a method and a device of the above-mentioned type which, alongside high quality of printed workpiece surfaces, enable a high variety of variants and/or individualization.

This object is achieved according to the invention by a method for applying patterns to a workpiece according to Claim 1, a device for carrying out the method according to Claim 12 as well as a computer program according to Claim 13. Particularly preferred embodiments are indicated in the dependent claims.

The invention is based on the knowledge that the variety of variants and individualization of printed workpiece surfaces are limited by the availability of suitable print templates and/or image files. Since although there are in principle a large variety of print templates and/or image files, these are often not available to the user, be it for technical or licensing reasons or simply because they cannot be found quickly. The invention therefore aims to provide the user with a tool with which the variety of variants and individualization of print templates and/or image files can be increased.

For this purpose, it is provided according to the invention that, in the case of a method for applying patterns to a workpiece of the above-mentioned type, at least one selection in terms of a decor for the application of patterns to the surface of the workpiece is performed, and that at least one image file is generated and/or adapted taking into account the at least one selection in a computer-assisted manner.

In this manner, it is made possible for the user to generate a desired image file as a basis for applying patterns to the surface of the workpiece without being restricted to certain available print templates and/or image files. As a result of this, a practically unlimited variety of variants and individualization of the application of patterns to the respective workpiece can be achieved. The quality of the printed workpiece surfaces is maintained and can possibly even be further improved.

In this regard, it is provided according to a further development of the invention that data in relation to the workpiece to which patterns are to be applied and/or a printing device to be used to apply patterns to the workpiece are provided and the computer-assisted generation and/or adapting of at least one image file is/are carried out taking into account the data in relation to the workpiece to which patterns are to be applied and/or the printing device to be used to apply patterns to the workpiece. As a result of this, an optimization in terms of the respective workpiece and/or the respective printing device can already be performed in the generation and/or adapting of the at least one image file. In this manner, the quality of the subsequent print result can be further improved or the necessity for subsequent optimization steps can be reduced.

It is particularly preferred that the provision of data in relation to the workpiece to which patterns are to be applied comprises one or more of the following workpiece parameters:
geometry of the surface to which patterns are to be applied,
material of the surface to which patterns are to be applied,
surface properties of the surface to which patterns are to be applied,
where applicable, existing application of patterns to the surface to which patterns are to be applied.

In this manner, the image file to be created or adapted can be particularly well matched to the existing and desired properties of the respective workpiece so that a particularly high-quality result of applying patterns is produced.

Similar advantages arise if, according to a further development of the invention, the provision of data in relation to the printing device to be used to apply patterns to the workpiece comprises one or more of the following print parameters:
print resolution of the printing device,
printing method of the printing device,
color spectrum of the printing device,
printing range of the printing device,
where applicable, existing station for pre-treatment, such as primers, and/or for after-treatment, such as coating.

As a result of the targeted taking into account of these parameters, a particularly high-quality print image can likewise be achieved, wherein the integration of these parameters into the process of creating or adapting the image file on one hand delivers particularly good results, and on the other hand reduces the necessity of subsequent method steps such as separate color management and/or RIP.

In the context of the invention, it is in principle possible that at least one image file is entirely newly generated in a computer-assisted manner so that there are no limits on creative freedom and individualization. According to a further development of the invention, it is, however, provided that a multiplicity of image files are provided on a data store, from which multiplicity of image files at least one is selected as a basis for applying patterns to the surface of the workpiece. This results in a reliable starting point which is clear to the user and on the basis of which a computer-assisted adaptation of the image file for the subsequent printing process can be performed quickly and with a low degree of computer power. The data store can be arranged both locally and also decentrally and, where applicable, be linked via an Internet connection or another suitable connection.

Various computer-assisted methods which can have recourse to simple or complex software components are considered in the context of the invention for the computer-assisted generation and/or adapting of at least one image file. It has been shown to be particularly advantageous that, according to a further development of the invention, the computer-assisted generation and/or adapting of at least one image file is/are carried out using artificial intelligence, in particular using at least one neural network. In this manner, entirely new possibilities of digital image processing and image generation can be opened up, as a result of which a vastly improved variety of variants and individualization are produced. At the same time, an extremely large plurality of parameters can be taken into account and combined in the adaptation or generation of the image file, both from an aesthetic perspective and from a technical perspective. A continuous process of improvement can furthermore be implemented, wherein the computer-assisted generation and/or adapting of the image file is/are ever increasingly oriented to the requirements of the user and the technical framework conditions which may arise, for example, from the respective workpieces and the printing device used.

Against this background, according to a further development of the invention, it is provided that the artificial intelligence is trained in advance and preferably also continuously by virtue of the fact that a plurality of image data together with a plurality of attributes and characteristics assigned to the respective image files are supplied to the artificial intelligence. As a result of this, it is made possible for the artificial intelligence to generate and/or adapt an image file in an effective and precise manner on the basis of the at least one selection made in terms of a decor for applying patterns to the surface of the workpiece and also to continuously improve this process of generation and/or adaptation.

The selection in terms of a decor for applying patterns to the surface of the workpiece can encompass a very wide range of steps and aspects in the framework of the invention. According to a further development of the invention, it is, however, provided that the performance of at least one selection has at least one, preferably more of the following steps:
selecting at least one image file,
supplying at least one image file which represents the decor for applying patterns to the surface of the workpiece, such as in particular an image file recorded by a detection device of a surface portion of the workpiece to which patterns have already been applied;
selecting at least one attribute and an associated characteristic for the image file,
performing at least one selection on a graphic user interface,
performing at least one selection by inputting at least one graphic character,
performing at least one selection by using an input device, a speech input and/or a gesture.

Examples of these selection steps and the advantages which arise from them will become apparent in greater detail on the basis of the following detailed description.

In the context of the present invention, various attributes can be called on for the training of the artificial intelligence. The artificial intelligence, however, delivers particularly exacting results if one or more of the following attributes are taken into account and/or made available for selection: class of material, type of material, texture, color shade, structure, gloss level, brightness, contrast and resolution.

According to a further development of the invention, it is furthermore provided that the computer-assisted adapting of at least one image file also encompasses recourse to at least one other image file which is classified as sufficiently similar taking into account the at least one selection. As a result of this, the quality of the image file and thus of the result of applying patterns can be further improved, for example in that the at least one other image file is called on in order to increase the pixel density or fill in gaps in the image file. In this way, it may also be possible to make a color adjustment.

According to a further preferred embodiment of the invention, the surface of the workpiece to which patterns are applied by means of the printing device is detected at least partially by means of a detecting device, and the detection result is compared with the image file on the basis of which patterns were applied to the surface of the workpiece, wherein the result of the comparison preferably flows into the computer-assisted generation and/or adapting of at least one future image file. As a result of this, the quality of the result of applying the patterns can be further improved since the results of earlier printing processes are taken into account in the generation or adapting of future image files and possibly also artificial intelligence can correspondingly be continuously improved.

The advantages which are mentioned above and also below can be achieved in a particularly pronounced manner if the method is performed by means of a device according to Claim 12 and using a computer program according to Claim 13.

### BRIEF DESCRIPTION OF THE DRAWINGS

FIG. 1 schematically shows an embodiment of a device for applying patterns to a workpiece as well as corresponding method steps;

FIG. 2 schematically shows a further embodiment of the method.

### DETAILED DESCRIPTION OF PREFERRED EMBODIMENTS

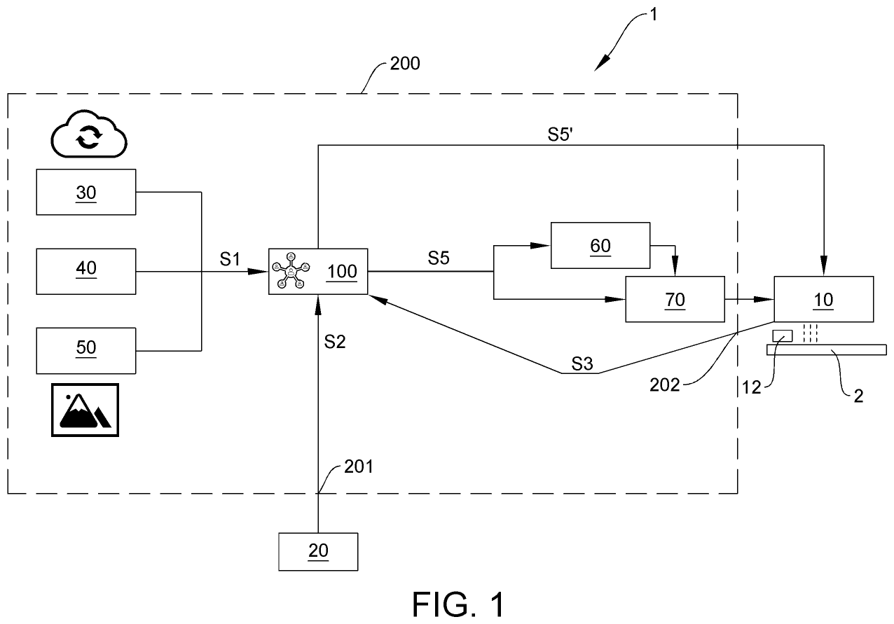

Embodiments of the invention are described below in detail with reference to the accompanying drawings. A device 1 for applying patterns to a workpiece 2 according to one embodiment of the invention is represented schematically in FIG. 1.

The workpiece 2 to which patterns are to be applied can be a plate- or strip-shaped workpiece which is composed, for example, entirely or partially of wood, wood materials or plastic. Often, wood-based workpieces are involved which are coated on their surface with a plastic material, wherein the coating material is to be applied in patterns by means of the device 1. Workpieces of this type are widely used in the furniture and component industry, for example as furniture fronts, doors, carcass parts, etc.

For the actual process of applying patterns, the device 1 comprises in the present embodiment a printing device 10, which can be, for example, a drop-on-demand printing device which applies, for example, ink or another suitable material on the surface of the workpiece.

The device 1 furthermore comprises a computer system 200 which serves to control the printing device 10 and prepare and make available the print data to be used. A computer system 200 can be a single PC which is connected directly to the printing device 10. Alternatively, however, the computer system 200 may also have several sub-systems connected to one another, which in principle can also be operated independently of one another and which may also be arranged at different locations, wherein suitable means of data transmission may then be provided.

The computer system 200 comprises in the present embodiment artificial intelligence 100 which can be configured, for example, as a neural network which is operated on the computer system 200. The artificial intelligence serves the purpose of computer-assisted generation and/or adapting of image files and can be configured, for example, as a convolutional neural network, although a variety of other neural networks are possible.

The computer system 200 furthermore comprises a database for image files, which in the present embodiment has a sub-database for “Images”, a sub-database for “Decors” and a sub-database for “Own recordings”. Although not shown in FIG. 1, the computer system 200 has an interface in order to feed the respective image files into the database or the sub-databases so that these can, where necessary, be passed on to the artificial intelligence.

The computer system 200 furthermore has an interface 201 by means of which data in relation to the workpiece to which patterns are to be applied can be received and passed on to the artificial intelligence 100. An interface 202 is additionally also provided in the computer system 200 in order to receive data in relation to the printing device 10 to be used and likewise pass on the data to the artificial intelligence 100. Of course, it is also possible to integrate the above-mentioned interfaces into one or more interfaces.

The artificial intelligence 100 in turn is connected via command output paths (S5, S5′) to the printing device 10 in order to transfer print data to be used to apply patterns to the workpiece 2 to the printing device 10.

Although not shown in FIG. 1, the computer system 200 comprises normal input devices, such as, for example, a keyboard, a display device, a touchscreen, a gesture input, a speech input, etc., so that a user can input various commands and, where necessary, make a selection. On this basis, one embodiment of the method according to the invention is performed as follows.

If a specific pattern or decor is supposed to be applied to a workpiece 2 on its surface, a user selects a suitable image file from one of the sub-databases 30, 40 or 50 on the computer system 200. Insofar as this image file already corresponds exactly to the conceptions of the user or the requirements, it can in principle be used in an unchanged manner for applying patterns to the workpiece. However, an exactly suitable print file is often not available and is also not easy to procure.

In this case, the user makes in step S1 at least one further selection in terms of the decor for applying patterns to the surface of the workpiece, for example that the properties of the preselected image file are to be changed in a specific manner, for example in terms of the brightness, the pattern, the resolution or various other parameters. This selection is provided to the artificial intelligence 100 which, on this basis, generates a new image file in a computer-assisted manner which takes into account the selection made by the user.

Instead of selecting an existing image file from one of the sub-databases 30, 40 or 50, the user can also use the artificial intelligence to generate an entirely new image. In this case, the user, in step S1, makes at least one selection (usually several selection steps) which describe(s) the desired properties of the image file such as “Texture oak rustic light in 600 dpi resolution”.

During selection or input, the user can have recourse to attributes and corresponding characteristics which are described in greater detail below.

Overall, the selection S1 in terms of a decor for applying patterns to the surface of the workpiece 2 can have at least one, preferably several of the following steps which are likewise performed in a computer-assisted manner in the present embodiment:
selecting at least one image file,
supplying at least one image file which represents the decor for applying patterns to the surface of the workpiece, such as in particular an image file recorded by a detection device of a surface portion of the workpiece to which patterns have already been applied;
selecting at least one attribute and an associated characteristic for the image file,
performing at least one selection on a graphic user interface. A very wide range of devices and symbols are considered as graphic user interfaces, such as touchscreens on which, for example, virtual control dials or sliding controls are provided.
performing at least one selection by inputting at least one graphic character,
performing at least one selection by using an input device, a speech input and/or a gesture.

Although it is not absolutely essential in the context of the invention, the artificial intelligence also calls on data S2 in relation to the workpiece to which patterns are to be applied and which are provided via the interface 201 and can be provided, for example, from a data source 20, such as a machine control unit, of a workpiece detection device or a user input when creating and/or adapting the at least one image file.

A very wide range of workpiece parameters can thus be provided to the artificial intelligence, such as the geometry (for example also the developed view, the material or the surface properties of the surface to which patterns are to be applied). Patterns which may already be present of the surface to which patterns are to be applied can also be provided as workpiece parameters and taken into account in the subsequent application of patterns to the workpiece.

In the present embodiment, the artificial intelligence furthermore also obtains via the interface 202 data in relation to the printing device 10 to be used to apply patterns to the workpiece 2 and takes these into account, possibly jointly with workpiece data obtained via the interface 201, in the computer-assisted generation and/or adapting of the at least one image file.

Here, a very wide range of print parameters can be handed over, such as, for example, the print resolution (e.g. in dpi), the printing method, the color spectrum or the print range of the printing device. In this manner, the artificial intelligence can also obtain information as to whether further stations for pre-treatment or after-treatment are assigned to the printing device 10, such as a primer station or a coating station for after-treatment. In this manner, the influence of any pre- and after-treatments on the subsequent print result can already be taken into account in the artificial intelligence, as well as the other print parameters.

The image file generated or adapted by the artificial intelligence 100 can subsequently be transferred via the connection S5′ to the printing device 10 so that the workpiece 2 can correspondingly be printed on this basis. The computer system 200 can previously also display the generated or adapted image file to the user for the purpose of approval.

Alternatively, the image file generated or adapted by the artificial intelligence 100 can also be transferred via the connection S5 to the printing device 10, wherein in this case an RIP 70 and, where necessary, color management 60 can be performed in order to optimize the image file for the print process. Due to the fact that the artificial intelligence has, however, already taken into account the properties of the printing device 10 in the generation or adapting of the image file, in such a case, however, a subsequent RIP 70 or color management 70 can be dispensed with, as a result of which the method sequence is significantly simplified and the print quality is improved.

Although it is in principle possible in the context of the invention to feed artificial intelligence already completely configured and trained for the tasks described above into the computer system 200, it is provided in the case of the present embodiment that the artificial intelligence is trained both in advance and also continuously with suitable training data, wherein the term continuously also refers to a process in which a training process is performed by means of new external and/or internal data at regular intervals. For the training of the artificial intelligence, a plurality of image files, for example thousands, tens of thousands or even more, are supplied to the artificial intelligence, and indeed together with the attributes and characteristics assigned to the respective image files. Examples for attributes and corresponding characteristics which are supplied to the artificial intelligence for each image file are summarized in the following table:

### Example for Training Data

| Attribute | Characteristics |
|---|---|
| Class of material | Wood, stone, plastic, . . . |
| Material type | Oak, beech, . . . , granite, marble, . . . , |
| | thermoset, thermoplastic, . . . |
| Texture | Plain, mottled, speckled, . . . |
| Color tone | Brown, gray, white, . . . |
| Structure | Fine, medium, rough, . . . |
| Gloss level | Matt, glossy, reflective, . . . |
| Brightness | Bright, medium, dark, . . . |
| Contrast | High, medium, low, . . . |
| Resolution | Value in dpi |

On the basis of the training data supplied (image files, attributes and characteristics), the neural network develops an understanding of the content and the assignment of the respective attributes and characteristics. In the course of the training process, e.g. 70% of the available images can be used for the actual training process, while, for example, 30% of the images can be called on as a control group, on the basis of which the reliability of the artificial intelligence is checked and, where necessary, corrected.

In the case of the computer-assisted adaptation of at least one image file, the artificial intelligence can, where necessary, also have recourse to at least one other image file which is provided, for example, by one of the sub-databases 30, 40, 50. This may, for example, be expedient if adequate pixel density cannot be achieved on the basis of the initially available data or if gaps or color inaccuracies arise in the image file in the course of the computer-assisted adaptation. In this case, the artificial intelligence can have recourse to another image file in order, for example, to increase the pixel density, fill in gaps or perform a color adaptation. The artificial intelligence particularly preferably has recourse here to an image file which, taking into account the at least one selection S1, is classified as sufficiently similar so that a high quality of the adapted image file to be used for the printing process is produced.

A further improvement in the print result can be achieved if, according to the present embodiment, a detection device 12 is provided which at least partially detects the surface, to which patterns are applied by means of the printing device 10, of the workpiece 2. The detection result of the detection device 12 can be compared with a setpoint value, such as, in particular, the image file used as the basis for the printing, in order to allow the result of the comparison to flow into the artificial intelligence and thus into the computer-assisted generation and/or adaptation of at least one future image file.

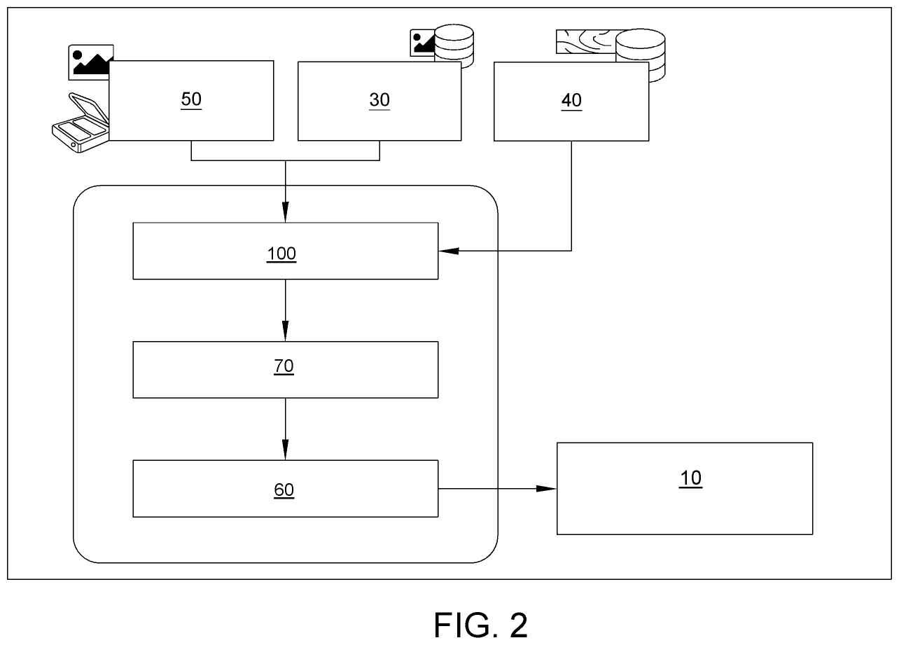

An alternative method sequence according to one embodiment of the invention is represented schematically and in a simplified manner in FIG. 2, wherein the sequence shown in FIG. 2 is in principle classified in the framework explained above with reference to FIG. 1. As shown in FIG. 2, an artificial intelligence 100 or another suitable computer algorithm is also used here in order to provide an image file for a printing device 1. A particular case connected to the sequence shown in FIG. 2 can lie in the fact that a workpiece in the region of a surface is already provided with a decor and is now in principle to be provided with the same decor in the region of an adjacent surface. These adjacent surfaces are, however, frequently coated with different materials, hence an optically identical decor requires different image files and print parameters since the coating materials bring about entirely different optical effects in the course of a printing process.

Against this background, it is possible in the context of the invention to firstly create a photo or a scan of the already printed surface of a workpiece and provide this, for example, in the sub-database 50 (“Own recordings”). This scan is supplied to the artificial intelligence 100 provided that the surface to be printed is supposed to have the same appearance as the surface scanned in. The artificial intelligence will now generate a new image file and in this respect have recourse to both the data S3 in relation to the printing device 1 to be used and the data S2 in relation to the workpiece 2 to be printed. With the aid of these data, the artificial intelligence 100 is able to adapt the image file in such a manner that, despite entirely different properties of the surface to be printed (in comparison to the adjacent, already printed surface) and possibly also despite an entirely different printing device, an identical print image is achieved on the two adjacent workpiece surfaces. For this purpose, the artificial intelligence 100 can also still have recourse to further image files which are stored in one of the sub-databases 30, 40 or 50.

The computer system can furthermore, where necessary, also perform a subsequent RIP 70 and/or color management 70 although this, as described above, is not absolutely essential.

In addition to an identical matching of the application of patterns to the surface to be printed and the already printed surface, various other effects can of course also be achieved, for example that precisely a deliberate differentiation of the adjacent printed surfaces is achieved which, however, furthermore has a recognizable similarity, such as, for example, identical types of wood with a different hue, different gloss level, etc.

1. Method for applying patterns to a workpiece which is preferably composed at least in portions of wood, wood material or plastic, having the steps:
performing at least one selection in terms of a decor for the application of patterns to the surface of the workpiece,
computer-assisted generation and/or adapting of at leas tone image file taking into account the at least one selection, and
at least partial application of patterns to the workpiece by means of a printing device.

2. Method according to claim 1, wherein
data in relation to the workpiece to which patterns are to be applied and/or data in relation to a printing device to be used to apply patterns to the workpiece are provided, and
the computer-assisted generation and/or adapting of at least one image file is/are carried out taking into account the data in relation to the workpiece to which patterns are to be applied and/or the data in relation to the printing device to be used to apply patterns to the workpiece.

3. Method according to claim 2, wherein the provision of data in relation to the workpiece to which patterns are to be applied comprises one or more of the following workpiece parameters:
geometry of the surface to which patterns are to be applied,
material of the surface to which patterns are to be applied,
surface properties of the surface to which patterns are to be applied,
where applicable, existing application of patterns to the surface to which patterns are to be applied.

4. Method according to claim 2 or 3, wherein the provision of data in relation to the printing device to be used to apply patterns to the workpiece comprises one or more of the following print parameters:
print resolution (e.g. dpi) of the printing device,
printing method of the printing device,
color spectrum of the printing device,
printing range of the printing device,
where applicable, existing station for pre-treatment, such as primers, and/or for after-treatment, such as coating.

5. Method according to claim 1, wherein a multiplicity of image files are provided on a data store, from which multiplicity of image files at least one is selected as a basis for applying patterns to the surface of the workpiece.

6. Method according to claim 1, wherein the computer-assisted generation and/or adapting of at least one image file is/are carried out using artificial intelligence, in particular using at least one neural network.

7. Method according to claim 7, wherein one or more of the following attributes are taken into account and/or made available for selection: class of material, type of material, texture, color shade, structure, gloss level, brightness, contrast and resolution.

8. Method according to claim 1, wherein performing at least one selection in terms of a decor for applying patterns to the surface of the workpiece has at least one, preferably more of the following steps:
selecting at least one image file,
supplying at least one image file which represents the decor for applying patterns to the surface of the workpiece, such as in particular an image file recorded by a detection device of a surface portion of the workpiece to which patterns have already been applied;
selecting at least one attribute and an associated characteristic for the image file,
performing at least one selection on a graphic user interface,
performing at least one selection by inputting at least one graphic character,
performing at least one selection by using an input device, a speech input and/or a gesture.

9. Method according to claim 1, wherein the computer-assisted adapting of at least one image file also encompasses recourse to at least one other image file which is classified as sufficiently similar preferably taking into account the at least one selection.

10. Method according to claim 1, wherein the surface of the workpiece to which patterns are applied by means of the printing device is detected at least partially by means of a detecting device, and the detection result is compared with the image file on the basis of which the surface of the workpiece was printed, wherein the result of the comparison preferably flows into the computer-assisted generation and/or adapting of at least one future image file.

11. Device for carrying out the method according to claim 1, having:
a printing device for at least partial application of patterns to the workpiece, and
a computer system for generating and/or adjusting at least one image file which has at least one interface for receiving data in relation to the workpiece to which patterns are to be applied and/or a printing device to be used to apply patterns to the workpiece and preferably also to receive image files.

12. Computer program which is stored on the computer system of the device according to claim 12 and is configured to assist the method according to any one of claims 1 to 11 by means of the computer system.
